(19) United States
(12) Patent Application Publication
(10) Pub. No.: US 2016/0054237 A1
(43) Pub. Date: Feb. 25, 2016

(54) SYSTEM AND METHOD FOR OPTICAL INSPECTION OF ELECTRONIC CIRCUITS

(71) Applicant: VIT, Saint-Egreve (FR)

(72) Inventor: Rémi GERBELOT, Saint Egreve (FR)

(73) Assignee: VIT, Saint Egreve (FR)

(21) Appl. No.: 14/783,491

(22) PCT Filed: Apr. 9, 2014
(86) PCT No.: PCT/FR2014/050853

§ 371 Date: Oct. 9, 2015

(30) Foreign Application Priority Data
Apr. 11, 2013 (FR) 1353275

(51) Int. Cl. G01N 21/956; G01N 21/95

(52) U.S. Cl. CPC G01N 21/95684; G01N 21/9501; G01N 2021/845

(57) ABSTRACT

An optical inspection system for an electronic circuit comprises sensors of images of the electronic circuit, at least two supports on which are intended to rest two parts of the electronic circuit and a device for modifying the position of each support, independently of one another.

The present patent application claims the priority benefit of French patent application FR13/53275 which is herein incorporated by reference.

### BACKGROUND

The present disclosure generally relates to optical inspection systems and, more specifically, to three-dimensional image determination systems intended for the on-line analysis of objects, particularly of electronic circuits.

### DISCUSSION OF THE RELATED ART

Optical inspection systems are generally used to verify the sound condition of an object before it is released to the market. They especially enable to determine a three-dimensional image of the object, which may be analyzed to search for possible defects. In the case of an electronic circuit comprising, for example, a printed circuit equipped with electronic components, the three-dimensional image of the electronic circuit may be used, in particular, to inspect the sound condition of the welds of the electronic components on the printed circuit.

An example of a three-dimensional image determination method comprises the acquisition of two-dimensional images of the circuit by digital cameras while images are projected on the circuit.

### SUMMARY

An embodiment provides an optical inspection system for an electronic circuit comprising sensors of images of the electronic circuit, at least two supports having two portions of the electronic circuit intended to rest thereon, and a device for modifying the position of each support, independently from each other.

According to an embodiment, the electronic circuit comprises a printed circuit, each support being intended to support a lateral edge of the printed circuit.

According to an embodiment, the system comprises a first conveyor capable of transporting the electronic circuit along a first direction, the supports extending parallel to the first direction.

According to an embodiment, the system comprises a second conveyor capable of transporting the image sensors along a second direction, non-parallel to the first direction, and, particularly, perpendicular to the first direction.

According to an embodiment, the device is capable of displacing each support, independently from each other, along a third direction, non-parallel to the first and second directions, and, particularly, perpendicular to the first and second directions.

According to an embodiment, the system comprises a device for locking the electronic circuit portions on the supports.

An embodiment also provides a method of optical inspection of an electronic circuit, at least two portions of the electronic circuit resting on two supports, the method comprising successive acquisitions of images of the electronic circuit by image sensors and the modification of the position of each support, independently from each other, between successive acquisitions.

According to an embodiment, the image sensors are displaced with respect to the electronic circuit at least from a first location to acquire images of a first portion of the electronic circuit to a second location to acquire images of a second portion of the electronic circuit, the supports being displaced to first positions when the image sensors are at the first location and to second positions, different from the first positions, when the image sensors are at the second location.

According to an embodiment, the first portion of the electronic circuit is in the focus area of the image sensors when the supports are in the first positions and the second portion of the electronic circuit is in the focus area of the image sensors when the supports are in the second positions.

According to an embodiment, when the supports are in the first positions, the second positions are determined based on the first positions and on an extrapolation of the shape of the second portion of the electronic circuit.

### BRIEF DESCRIPTION OF THE DRAWINGS

The foregoing and other features and advantages will be discussed in detail in the following non-limiting description of specific embodiments in connection with the accompanying drawings, among which:

FIG. 1 is a partial simplified top view of an embodiment of a system of optical inspection of electronic circuits;

FIG. 2 is a partial simplified cross-section view of the optical inspection system of FIG. 1 along line II-II;

FIG. 3 shows in the form of a block diagram an embodiment of a method of correcting deformations of an electronic circuit;

FIGS. 4 and 5 show curves of the variation of the profile of an electronic circuit in the absence of a correction and when an embodiment of the method of correcting the deformations of the electronic circuit is implemented;

FIG. 6 shows a curve of variation of the distance between the position of the electronic circuit and a reference position when an embodiment of the method of correcting the deformations of the electronic circuit is implemented; and

FIGS. 7 and 8 are partial simplified cross-section views of the optical inspection system of FIG. 1 illustrating two additional advantages of an embodiment of the correction method.

### DETAILED DESCRIPTION

For clarity, the same elements have been designated with the same reference numerals in the various drawings and, further, the various drawings are not to scale. In the following description, unless otherwise indicated, terms “substantially”, “approximately”, and “in the order of mean “to within 10%”. Further, only those elements which are useful to the understanding of the present description have been shown and will be described. In particular, the means for conveying the printed circuit and the means for conveying the cameras and the projectors of the optical inspection system described hereafter are within the abilities of those skilled in the art and are not described in detail.

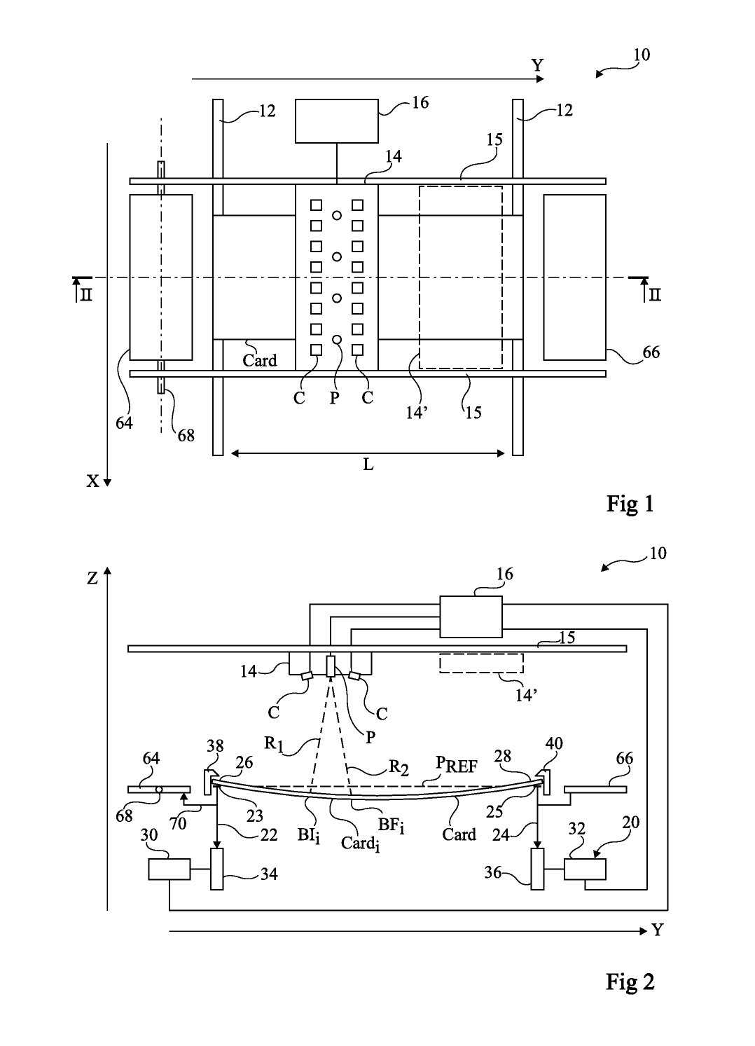

FIG. 1 very schematically shows a system 10 of inspection of an electronic circuit Card. Term electronic circuit indifferently designates an assembly of electronic components interconnected via a support, the support alone used to form this interconnection without the electronic components, or the support without the electronic components but provided with means for attaching the electronic components. As an example, the support is a printed circuit and the electronic components which are attached to the printed circuit by welding seams obtained by heating welding paste blocks. In this case, electronic circuit indifferently designates the printed circuit alone (with no electronic components or welding paste blocks), the printed circuit provided with the welding paste blocks and without electronic components, the printed circuit provided with the welding paste blocks and electronic components before the heating operation, or the printed circuit provided with the electronic components attached to the printed circuit by welding seams. The dimensions of circuit Card for example correspond to a rectangular card having a length and a width varying from 50 mm to 550 mm.

Electronic circuit Card to be inspected is placed on a conveyor 12, for example, a planar conveyor. Conveyor 12 is capable of displacing circuit Card along a direction X, for example, a horizontal direction, from a circuit introduction position to an inspection position and from the inspection position to a circuit recovery position. As an example, conveyor 12 may comprise an assembly of straps and rollers driven by a rotating electric motor, not shown. As a variation, conveyor 12 may comprise a linear motor displacing a carriage having electronic circuit Card resting thereon.

Optical inspection system 10 comprises a device of image projection on circuit Card comprising projectors P, four aligned projectors being, as an example, schematically shown in FIG. 1. System 10 further comprises an image acquisition device comprising image sensors or digital cameras C. As an example, sixteen cameras are schematically shown in FIG. 1, aligned in two rows of cameras on either side of the row of projectors P and each projector P is placed substantially at the center of a square having each corner occupied by a camera C. The assembly comprising projectors P and cameras C, called projector-camera block 14 hereafter, may be displaced by a conveyor 15 along a direction Y, for example, a horizontal direction, perpendicular to direction X. As an example, the projector-camera block has been shown by a dotted line 14′ at another position along direction Y.

Optical inspection system 10 enables to determine a three-dimensional image of electronic circuit Card. In the following description, three-dimensional image or 3D image designates a cloud of points, for example, comprising several million points, of at least a portion of the external surface of the circuit, where each point of the surface is tracked by its coordinates determined with respect to a three-dimensional space reference system. Further, two-dimensional image, or 2D image, is used to designate a digital image acquired by one of cameras C and corresponding to a pixel array. In the following description, unless otherwise indicated, term image refers to a two-dimensional image. Further, in the following description, field of view of projector-camera block 14 designates the portion of real space captured by cameras C during the image acquisition and enabling to determine a three-dimensional image.

Cameras C and projectors P are connected to an image processing computer system 16. Processing system 16 may comprise a computer or a microcontroller comprising a processor and memories of different types including a non-volatile memory having instructions stored therein, the execution thereof by the processor enabling processing system 16 to carry out the desired functions. As a variation, system 16 may correspond to a dedicated electronic circuit or to a combination of a plurality of processing units of different technologies. Processing system 16 is capable of determining a three-dimensional image of circuit Card by projection of images, for example, comprising fringes, on circuit Card to be inspected.

In order for the three-dimensional image to be accurately determined, the two-dimensional images acquired by cameras C should not be blurred. Circuit Card should thus be placed in the focus area of cameras C. To achieve this, circuit Card is brought by conveyor 12 at the level of a reference plane P_{REF} having a known position relative to cameras C.

However, the printed circuit may comprise deformations, particularly a warping or a distortion. The depth of field of cameras C should thus be sufficiently large to ascertain that sharp images of the circuit can be acquired whatever the circuit deformations. This requires using expensive cameras and opto-mechanical systems enabling to obtain a large depth of field.

Further, the dimensions of circuit Card are generally greater than the field of view of cameras C. The determination of a three-dimensional image of the entire circuit Card is then obtained by bringing projector-camera block 14 along direction Y to a plurality of fixed positions relative to circuit Card, images being acquired by cameras C at each position of projector-camera block 14. Such positions are called image acquisition positions hereafter. To decrease the number of images to be acquired, the image acquisition positions are selected so that the portion of circuit Card in the field of view of cameras C at an image acquisition position covers as little as possible the portion of circuit Card in the field of view of cameras C at the next image acquisition position.

However, if the circuit has a convex shape facing projector-camera block 14, for example, locally, portions of circuit Card may remain outside of the fields of view of cameras C at the different image acquisition positions. It is thus necessary to provide a partial overlapping of the acquired images of the portions of circuit Card by cameras C at two successive image acquisition positions. This increases the duration of an operation of determining the three-dimensional image of the entire circuit Card.

Further, the cameras are arranged with respect to the projectors in order not to receive the direct reflection of the incident beams projected by the projectors on the circuit. To achieve this, a minimum angle should generally be provided between the optical axes of the cameras and the optical axes of the associated projectors. This angle is determined by considering that the circuit is flat. This angle is determined by different contradictory parameters. To decrease the mechanical bulk and improve the radiometric balance, it is desirable for this angle to be as small as possible. However, to avoid a dazzling of the cameras and improve the system accuracy, it is desirable for this angle to be as large as possible.

However, if circuit Card has a domed shape, the beams emitted by the projectors may be deviated with respect to the case where the circuit is flat and may reach cameras C. The determination of the angles between the optical axes of the cameras and the optical axes of the associated projectors may be difficult if the previously-described constraints and the possible deformations of circuit Card are desired to be taken into account.

Thus, an object of an embodiment is to overcome all or part of the disadvantages of previously-described optical inspection systems.

Another object of an embodiment is to compensate for the deformations of electronic circuits during an image acquisition by the cameras of the optical inspection system.

Another object of an embodiment is to decrease the depth of field of the cameras.

Another object of an embodiment is to decrease the overlapping of the visual fields of the cameras to two successive image acquisition positions.

Another object of an embodiment is to bring the cameras closer to the projectors.

Another object of an embodiment is to decrease the duration of an operation of determining a complete three-dimensional image of an electronic circuit.

Another object of an embodiment is for the correction method to be compatible with a use at an industrial scale.

FIG. 2 shows a partial simplified cross-section view of FIG. 1 along line II-II of an embodiment of optical system 10. Conveyor 12 is not shown in FIG. 2. As an example, circuit Card is shown with a generally downward-facing convexity which is exaggerated for illustration purposes. It should however be clear that the deformations of circuit Card cannot be regular along direction Y. In particular, in a cross-section plane perpendicular to direction X, circuit Card may comprise portions with an upward convexity and portions with a downward convexity. However, in the case of a warping, the deformations are generally substantially independent from direction X. Generally, for a circuit Card having the shape of a rectangular card with a length and a width varying from 50 mm to 550 mm, the deformations measured along a direction Z perpendicular to directions X and Y are generally smaller than a few millimeters.

According to an embodiment, the determination of a three-dimensional image of the entire circuit Card, possibly except for the edges of circuit Card which may not be intended to be inspected by optical inspection system 10, is performed by displacing projector-camera block 14 along direction Y at a plurality of positions relative to circuit Card, images being acquired by the cameras at each image acquisition position.

As an example, the general field of view of projector-camera block 14 has been schematically shown by two dotted lines R₁, R₂. Reference Cardᵢ designates the portion of electronic circuit Card, a three-dimensional image of which may be determined by processing system 16 based on the images acquired by cameras C for a given image acquisition position of projector-camera block 14.

The three-dimensional images of an integer N of circuit portions Cardᵢ, where i is an integer varying from 1 to N, should be acquired to determine the three-dimensional image of the entire circuit Card. As an example, N typically varies from 1 to 10. Each circuit portion Cardᵢ comprises an initial edge BIᵢ, which is the leftmost edge of FIG. 2, and a final edge BFᵢ, which is the rightmost edge in FIG. 2.

According to an embodiment, to decrease the number of images to be acquired to determine the three-dimensional image of the entire circuit Card, possibly except for the circuit edges, the image acquisition positions are selected so that the overlapping between circuit portion Cardᵢ in the field of view of projector-camera block 14 at an image acquisition position and circuit portion Cardᵢ₊₁ in the field of view of projector-camera blocks 14 at the next image acquisition position is smaller than 20% of the length of circuit portion Cardᵢ measured along direction Y, and preferably substantially zero. This means that final edge BFᵢ of circuit portion Cardᵢ substantially corresponds to initial edge BIᵢ₊₁ of the next circuit portion Cardᵢ₊₁.

System 10 comprises a device 20, not shown in FIG. 1, capable of taking circuit Card closer to or away from projector-camera block 14. Device 20 is capable of independently displacing two different portions of circuit Card, each along direction Z. As an example, direction Z is the vertical direction.

According to an embodiment, device 20 comprises two supports 22, 24 which substantially extend along direction X. Support 22 comprises an upper end 23 which may bear against a lateral edge 26 of circuit Card and support 24 comprises an upper end 25 which may bear against the opposite lateral edge 28 of circuit Card. Ends 23 and 25 may contain straps, not shown, enabling to convey the electronic circuits. As an example, each end 23, 25 comprises a planar portion which extends across the entire width of circuit Card, along direction X. As an example, a strip of conveyor 12, not shown in FIG. 2, may be sandwiched between edge 26 of circuit Card and support 22 or between edge 28 of circuit Card and support 24 when supports 22, 24 are brought against edges 26, 28 of circuit Card.

Device 20 is capable of modifying height Z₁ of the top of support 22 and height Z₂ of the top of support 24 independently from each other. As an example, device 20 comprises two motors 30, 32, for example, step-by-step rotary electric motors, each rotating a cam 34, 36 around an axis parallel to direction Y. Each cam 34, 36 is, for example, a cam with an external profile having a portion of the associated support 22, 24 resting thereon. Height Z₁ depends on the angular position of cam 34 and height Z₂ depends on the angular position of cam 36. Motors 30, 32 are controlled by processing system 16. As a variation, linear actuators which directly displace supports 22, 24 along direction Z may be used.

Device 20 further comprises a device 38 for locking edge 26 of circuit Card on support 22 and a device 40 for locking edge 28 on support 24. Each locking device 38, 40 follows the displacement of the associated support 20, 22 along direction Z. Locking systems 38, 40 are controlled by processing system 16 to maintain edges 26, 28 of circuit Card against supports 22, 24 after circuit Card has been displaced along direction X all the way to the position where the image acquisitions are performed. As an example, each locking device 38, 40 corresponds to a clamp actuated by an actuator controlled by processing system 16.

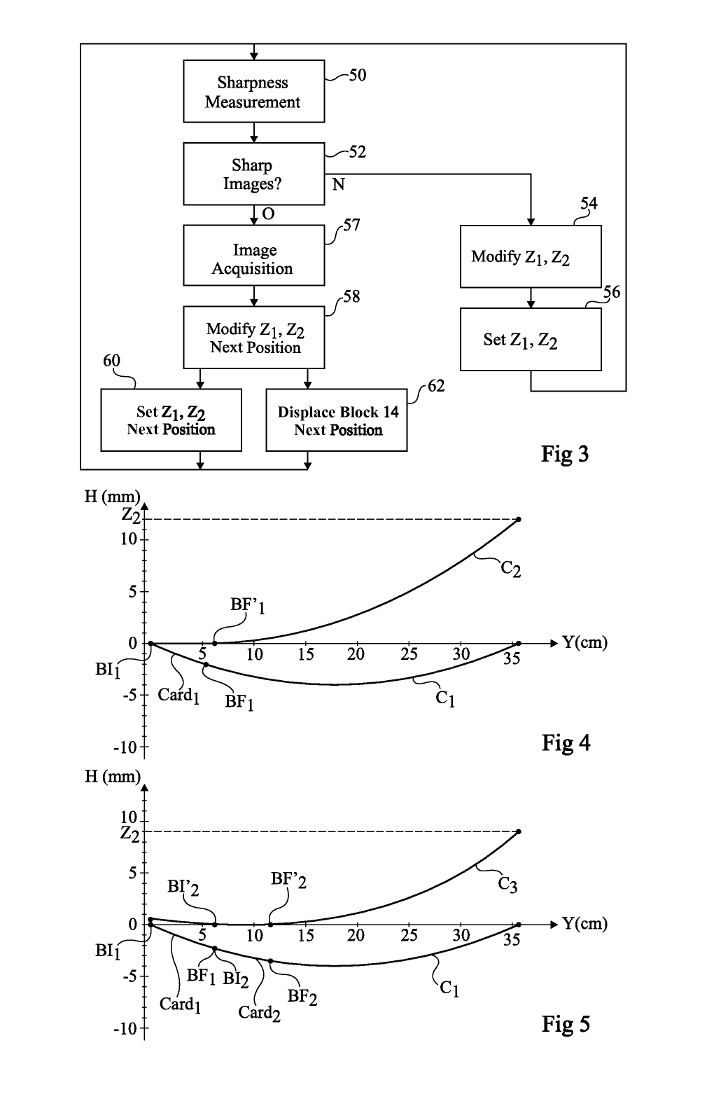

FIG. 3 shows, in the form of a block diagram, an embodiment of a method of compensating for or of correcting the deformations of circuit Card. A cycle of steps will be described during the determination of the three-dimensional image of circuit portion Cardᵢ, which corresponds to a given image acquisition position of projector-camera block 14. The cycle is repeated for each circuit portion Cardᵢ. The principle of this embodiment is to modify height Z₁ and Z₂ during the acquisition of images of circuit portion Cardᵢ so that the entire circuit portion Cardᵢ is located in the vicinity of plane P_{REF}. This may be obtained by bringing edges BIᵢ and BFᵢ substantially into plane P_{REF}. Heights Z₁ and Z₂ can thus be modified for each image acquisition position.

At step 50, processing system 16 determines the sharpness of images of circuit portion Cardᵢ which would be acquired by cameras C of projector-camera block 14. According to an embodiment, step 50 is implemented with no acquisition of two-dimensional images of circuit portion Cardᵢ by cameras C. According to a first example, a distance measurement device, for example, a laser range-finder, may be provided and connected to processing system 16. The processing system determines what the sharpness of images of circuit portion Cardᵢ acquired by cameras C from the measurements provided by the range-finder would be. According to a second example, step 50 is implemented by the acquisition of two-dimensional images of circuit portion Cardᵢ by image acquisition devices other than cameras C. According to another embodiment, step 50 is implemented by the acquisition of two-dimensional images of circuit portion Cardᵢ by cameras C of projector-camera bock 14. Processing system 16 can then determine a three-dimensional image of circuit portion Cardᵢ of the circuit. Processing system 16 determines whether circuit portion Cardᵢ clearly appears on the two-dimensional images acquired by cameras C by analysis of the two-dimensional images or on determination of the three-dimensional image. In particular, processing system 16 is capable of determining whether circuit portion Cardᵢ is partly or totally located in the focus area of cameras C, before the first sharp plane of cameras C or after the last sharp plane of cameras C. The method carries on at step 52.

At step 52, processing system 16 determines whether the sharpness of the two-dimensional images acquired by cameras C or which would be acquired by cameras C is sufficient to determine a three-dimensional image at the desired accuracy. If all or part of portion Cardᵢ does not sharply appear on the pictures acquired or to be acquired by cameras C, the method carries on at step 54.

At step 54, processing system 16 determines heights Z₁ and Z₂ to be provided so that the entire circuit portion Cardᵢ sharply appears on the images acquired or to be acquired by cameras C.

As an example, first circuit portion Card₁ is close to edge 26, which has a known position. Indeed, edge 26 is initially maintained in reference plane P_{REF}, which is part of the focus area of cameras C. In this case, height Z₂ is modified so that final edge BF₁ of circuit portion Card₁ is taken back into reference plane P_{REF}. The new value of height Z₂ is for example determined based on the position of edge BF₁ relative to plane P_{REF} determined by analysis of the range-finder measurements, based on the images acquired by the image acquisition devices other than cameras C, on the images acquired by cameras C, and/or during the determination of the 3D image of circuit portion Card₁.

As an example, for a circuit portion Cardᵢ, edge BIᵢ is located in plane P_{REF} or at least in the focus area of cameras C after the settings of heights Z₁ and Z₂ at the previous cycle. In this case, heights Z₁ and Z₂ are modified so that initial edge BIᵢ is maintained in reference plane P_{REF} and that final edge BFᵢ is taken back into reference plane P_{REF}. The new values of height Z₁ and Z₂ are determined based on the position of edge BFᵢ relative to plane P_{REF} determined by analysis of the range-finder measurements, on the images acquired by the image acquisition devices other than cameras C, on the images acquired by cameras C, and/or during the determination of the 3D image of circuit portion Cardᵢ. The method carries on at step 56.

At step 56, motors 30 and 32 are actuated by processing system 16 to take the tops of supports 22 and 24 respectively up to heights Z₁ and Z₂. The method carries on at step 50.

At step 52, if the entire portion Cardᵢ sharply appears on the images acquired or to be acquired by cameras C, the method carries on at step 57.

At step 57, two-dimensional images of circuit portion Cardᵢ are acquired by cameras C of projector-camera block 14 and processing system 16 determines a three-dimensional image of circuit portion Cardᵢ of the circuit. However, if, at step 50, two-dimensional images have already been acquired by cameras C and a three-dimensional image has already been determined, step 57 is not present. If, at step 50, two-dimensional images have already been acquired by cameras C but there has been no determination of a three-dimensional image, the three-dimensional image is determined at step 57. The method carries on at step 58.

At step 58, processing system 16 determines the new values of heights Z₁ and Z₂ so that the entire circuit portion Cardᵢ₊₁ sharply appears on the images which will be acquired by cameras C at the next position of projector-camera bock 14.

As an example, for a circuit portion Cardᵢ, edge BIᵢ is substantially located in plane P_{REF} or at least in the focus area of cameras C after the settings of heights Z₁ and Z₂ at the previous cycle. In this case, heights Z₁ and Z₂ may be modified so that initial edge BIᵢ₊₁ of portion Cardᵢ₊₁, which substantially corresponds to final edge BFᵢ of circuit portion Cardᵢ, is maintained in reference plane P_{REF} and that final edge BFᵢ₊₁ of portion Cardᵢ₊₁ is taken back into reference plane P_{REF}. Since no image of circuit portion Cardᵢ₊₁ has been acquired yet, the new values of heights Z₁ and Z₂ may be determined by extrapolation from the general shape of portion Cardᵢ, for example, considering that circuit portion Cardᵢ₊₁ has substantially the same shape as circuit portion Cardᵢ, taking into account the curvature variation of the previous circuit portions Cardᵢ, Cardᵢ₋₁, Cardᵢ₋₂, . . . , taking into account the profiles of the identical electronic circuits previously measured or by instantaneous measurement of circuit portion Cardᵢ to be inspected, or by combination of these solutions. The method carries on at steps 60 and 62, which may be carried out independently from each other, for example, successively or at least partly simultaneously.

At step 60, motors 30 and 32 are actuated by processing system 16 to displace supports 22 and 24 to the new values of the heights, respectively Z₁ and Z₂. The method carries on at step 50.

At step 62, projector-camera block 14 is displaced to the next position along direction Y for the determination of the three-dimensional image of circuit portion Cardᵢ₊₁. Step 62 may be carried out at least partly simultaneously at step 58 and/or at step 60. The method carries on at step 50.

FIG. 4 shows an example of curve C₁ showing height H, measured along direction Z, of the average profile of circuit Card in a cross-section plane perpendicular to direction X when the tops of supports 22 and 24 are located in reference plane P_{REF}, which corresponds to the axis of abscissas. According to this example, printed circuit Card has a general downward convexity, substantially symmetrical, with a maximum deflection of 4 mm. Curve C₂ represents the median line of circuit Card after the modification of height Z₂. Edges BI₁ and BF₁ have been shown before the modification of height Z₂ and edge BF₁′ has been shown after the modification of height Z₂. Edge BF₁′ is substantially brought into reference plane P_{REF} so that the entire circuit portion Card₁ of curve C₂ is located close to reference plane P_{REF}.

FIG. 5 is similar to FIG. 4 and shows an example of curve C₃ showing height H of the average profile of circuit Card after the modification of heights Z₁ and Z₂ for the image acquisition of circuit portion Card₂. It shows edges BI₂ and BF₂ before correction and edges BI₂′ and BF₂′ after the modification of heights Z₁ and Z₂. Edges BI1′ and BF2′ are substantially brought into reference plane P_{REF} so that the entire circuit portion Card₂ of curve C₃ is located close to reference plane P_{REF}.

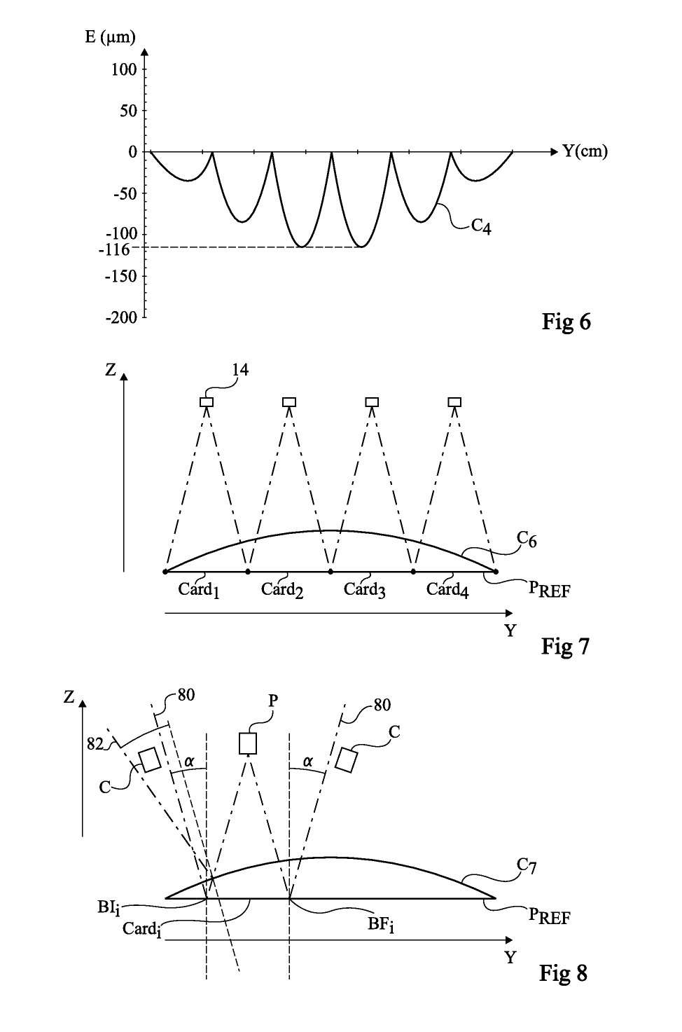

FIG. 6 shows a curve of variation C₄ of distance E, measured along direction Z, between a point of circuit Card seen in cross-section view along a plane perpendicular to direction X and reference plane P_{REF} during the image acquisition for each circuit portion Card₁ to Card_{N}. The maximum interval appears to be of 116 μm only, that is, much smaller than the maximum deflection of circuit Card, which is 4 mm. Thereby, the depth of field of cameras C to be provided to ascertain that each circuit portion Card₁ to Card_{N} sharply appears on the acquired images when the correction method is implemented is smaller than the depth of field which is necessary in the absence of a correction.

It is generally necessary to provide a step of calibrating optical inspection system 10 and particularly cameras C. This may be performed by the use of tools adapted according to the parameters to be calibrated. As an example, in FIGS. 1 and 2, two calibration tools 64, 66 have been shown on either side of conveyor 12. To carry out a calibration operation, projector-camera block 14 is displaced by conveyor 15 to successively come vertically above each calibration tool 64, 66. A calibration operation generally requires modifying the position of calibration tool 64, 66 according to a succession of movements which depends on the considered calibration tool. As an example, calibration tool 64 corresponds to a geometry test pattern. Test pattern 64 is assembled on a pivoting shaft 68. A calibration operation comprises pivoting test pattern 64 according to different inclinations. As an example, calibration tool 66 is used for a radiometric calibration of cameras C. A calibration operation comprises displacing along direction Z calibration tool 66 with respect to cameras C. Conventionally, the optical inspection system comprises motors dedicated to the displacements of calibration tools 64, 66 to carry out the calibration operations.

According to an embodiment, calibration tool 64 is connected to support 22 and calibration tool 66 is connected to support 24. As an example, calibration tool 66 is rigidly assembled to support 24 and displaces parallel to support 24 along direction Z. As an example, support 22 comprises a finger 70 capable of bearing against calibration tool 64 to pivot calibration tool 64 according to an inclination which depends on height Z₁ of support 22. Resilient return means, not shown, may be provided to permanently bring calibration tool 64 back to a position of equilibrium. This embodiment advantageously enables to use device 20 to displace calibration tools 64, 66. It is then no longer necessary to provide dedicated actuation means.

FIG. 7 illustrates another advantage of the implementation of an embodiment of the correction method. Preferably, projector-camera block 14 is displaced so that final edge BFᵢ of circuit portion Cardᵢ in the field of view of projector-camera block 14 corresponds to initial edge BIᵢ₊₁ of the next circuit portion Cardᵢ₊₁ when circuit Card extends along reference plane P_{REF}. However, when the circuit comprises a portion having an upward convexity (curve C₆), in the absence of a correction, certain portions of the circuit are not longer in the field of view of projector-camera block 14. In the absence of a correction, it is then necessary to provide overlap areas between adjacent fields of view which are oversized to take into account possible deformations of the circuit. The correction then enables to return to a case similar to the case where circuit Card is substantially planar.

FIG. 8 illustrates another advantage of the implementation of an embodiment of the correction method. Cameras C are placed relative to projectors P so as not to be in the area of direct reflection of the incident beams emitted by the projectors. Schematically, in a plane perpendicular to direction X, considering that each projector P emits an incident beam according to a cone having an apical angle a which covers circuit portion Cardᵢ, cameras C should be arranged beyond angle α with respect to a vertical axis crossing edge BIᵢ or BFᵢ in the case where the circuit extends along reference plane P_{REF}. In FIG. 8, the limit of the area of direct reflection in the case of a planar circuit Card is delimited by dotted lines 80. However, when the circuit comprises a portion having an upward convexity (curve C₇), the area of direct reflection of the incident beam is modified. In FIG. 8, the limit of the area of direct reflection in the case of a convex circuit Card is delimited by a ray in dotted lines 82. Thereby, in the absence of a correction, light rays may be deviated so that certain cameras C are located in the area of direct reflection modified by the convex portion of the circuit.

Specific embodiments have been described. Various alterations and modifications will occur to those skilled in the art. In particular, although previously-described system 10 is capable of implementing a method of determining a three-dimensional image of an object by image projection on the object, it should be clear that the three-dimensional image determination method may be different, for example, by implementing methods of analysis of images acquired by the cameras with no image projection onto the circuit.

1. An optical inspection system for an electronic circuit comprising sensors of images of the electronic circuit, at least two supports having two portions of the electronic circuit intended to rest thereon, and a device for modifying the position of each support, independently from each other.

2. The system of claim 1, wherein the electronic circuit comprises a printed circuit, each support being intended to support a lateral edge of the printed circuit.

3. The system of claim 1, comprising a first conveyor capable of transporting the electronic circuit along a first direction, the supports extending parallel to the first direction.

4. The system of claim 3, comprising a second conveyor capable of transporting the image sensors along a second direction, non-parallel to the first direction, and, particularly, perpendicular to the first direction.

5. The system of claim 4, wherein the device is capable of displacing each support, independently from each other, along a third direction, non-parallel to the first and second directions, and, particularly, perpendicular to the first and second directions.

6. The system of claim 1, comprising a device for locking the portions of the electronic circuit on the supports.

7. A method of optical inspection of an electronic circuit, at least two portions of the electronic circuit resting on two supports, the method comprising successive acquisitions of images of the electronic circuit by image sensors and the modification of the position of each support, independently from each other, between successive acquisitions.

8. The method of claim 7, wherein the image sensors (C) are displaced relative to the electronic circuit at least from a first location to acquire images of a first portion of the electronic circuit to a second location to acquire images of a second portion of the electronic circuit, the supports being displaced to first positions when the image sensors are at the first location and to second positions, different from the first positions, when the image sensors are at the second location.

9. The method of claim 8, wherein the first portion of the electronic circuit is in the focus area of the image sensors when the supports are in the first positions and the second portion of the electronic circuit is in the focus area of the image sensors when the supports are in the second positions.

10. The method of claim 9, wherein, when the supports are in the first positions, the second positions are determined based on the first positions and on an extrapolation of the shape of the second portion of the electronic circuit.
